(19) United States
(12) Patent Application Publication
(10) Pub. No.: US 2020/0042420 A1
(43) Pub. Date: Feb. 6, 2020

(54) BATCH APPLICATION PERFORMANCE PREDICTION

(71) Applicant: International Business Machines Corporation, Armonk, NY (US)

(72) Inventors: Shan Gao, Beijing (CN); Li Gao, Beijing (CN); Qian Ren, Beijing (CN); Xiao Hai Ma, Beijing (CN); Ze Zhang, Beijing (CN); Li Wei Zhang, Beijing (CN); Bin Chen, Beijing (CN); Ting Ting Tang, Beijing (CN)

(21) Appl. No.: 16/054,506

(22) Filed: Aug. 3, 2018

(51) Int. Cl. G06F 11/34; G06F 9/50

(52) U.S. Cl. CPC G06F 11/3428; G06F 9/5038; G06F 2201/81; G06F 11/3447; G06F 11/3419; G06F 11/3433

(57) ABSTRACT

A computer-implemented method, a device and a computer program product are proposed. The method comprises obtaining a resource service time of a transaction of an application. The resource service time indicates a time period when the transaction occupies a computer resource. The method further comprises obtaining a time-resource model. The time-resource model indicates a historical relationship among the resource service time, a resource wait time of the transaction, and a reference resource utilization of a second transaction of a second application. The resource wait time indicates a time period when the transaction waits for the computer resource to become available, and the reference resource utilization indicates a degree of the second transaction occupying the computer resource during a time period when the second transaction is running Additionally, the method further comprises determining transaction run time based on the resource service time and the time-resource model.

### BACKGROUND

The present invention relates to data prediction, and more specifically, to predicting batch application performance.

Today, a large number of IT departments need to handle enormous batch workloads daily. Batch processing is the execution of a series of jobs or applications in a program on a computer without manual intervention in a non-interactive manner. For example, the batch processing may be creating an index for each user record. The batch processing has several benefits over the customized processing. For example, the batch processing can shift the time of application processing to when the computing resources are less busy, avoid idling the computing resources with minute-by-minute manual intervention and supervision, run the application only once for many transactions, which significantly reduces the system overhead. In view of the advantages and the wide use of batch processing, improvements in the performance of batch processing are desired.

### SUMMARY

According to one embodiment, there is provided a computer-implemented method. The method comprises obtaining a resource service time of a transaction of an application. The resource service time indicates a time period when the transaction occupies a computer resource. The method further comprises obtaining a time-resource model. The time-resource model indicates a historical relationship among the resource service time, a resource wait time of the transaction, and a reference resource utilization of a second transaction of a second application. The resource wait time indicates a time period when the transaction waits for the computer resource to become available, and the reference resource utilization indicates a degree of the second transaction occupying the computer resource during a time period when the second transaction is running Additionally, the method further comprises determining a transaction run time based on the resource service time and the time-resource model. The transaction run time indicates a time period when the transaction is running.

According to another embodiment, there is provided a device. The device comprises a processing unit and a memory coupled to the processing unit and storing instructions thereon. The instructions, when executed by the processing unit, perform acts comprising: obtaining a resource service time of a transaction of an application, the resource service time indicating a time period when the transaction occupies a computer resource; obtaining a time-resource model, the time-resource model indicating a historical relationship among the resource service time, a resource wait time of the transaction, and a reference resource utilization of a second transaction of a second application, the resource wait time indicating a time period when the transaction waits for the computer resource to become available, and the reference resource utilization indicating a degree of the second transaction occupying the computer resource during a time period when the second transaction is running; and determining a transaction run time based on the resource service time and the time-resource model, the transaction run time indicating a time period when the transaction is running.

According to yet another embodiment, there is provided a computer program product being tangibly stored on a non-transient machine-readable medium and comprising machine-executable instructions. The instructions, when executed on a device, cause the device to: obtain a resource service time of a transaction of an application, the resource service time indicating a time period when the transaction occupies a computer resource; obtain a time-resource model, the time-resource model indicating a historical relationship among the resource service time, a resource wait time of the transaction, and a reference resource utilization of a second transaction of a second application, the resource wait time indicating a time period when the transaction waits for the computer resource to become available, and the reference resource utilization indicating a degree of the second transaction occupying the computer resource during a time period when the second transaction is running; and determine a transaction run time based on the resource service time and the time-resource model, the transaction run time indicating a time period when the transaction is running.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

Understanding that the drawings depict only illustrative embodiments and are not therefore to be considered limiting in scope, the illustrative embodiments will be described with additional specificity and detail through the use of the accompanying drawings, in which:

FIG. 1 depicts one embodiment of an example cloud computing node;

FIG. 2 depicts one embodiment of an example cloud computing environment;

FIG. 3 depicts one embodiment of example abstraction model layers;

FIG. 4 depicts one embodiment of an example schematic diagram of transaction run time;

FIG. 5 is a flow chart depicting one embodiment of an example predicting method;

FIG. 6 depicts one embodiment of an example schematic diagram of historical values;

FIG. 7 depicts one embodiment of an example schematic diagram of collecting historical values in a database;

FIG. 8 depicts one embodiment of an example schematic diagram of performing curve fitting on historical values to determine a time-resource model;

FIG. 9 depicts one embodiment of an example schematic diagram of an example application schedule;

FIG. 10 depicts one embodiment of an example schematic diagram of another example application schedule;

FIG. 11 is a flow chart depicting one embodiment of an example predicting method.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

As used herein, the term “includes” and its variants are to be read as open ended terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

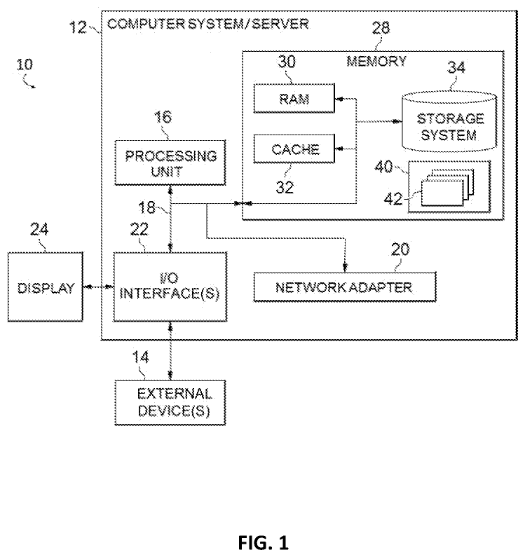

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

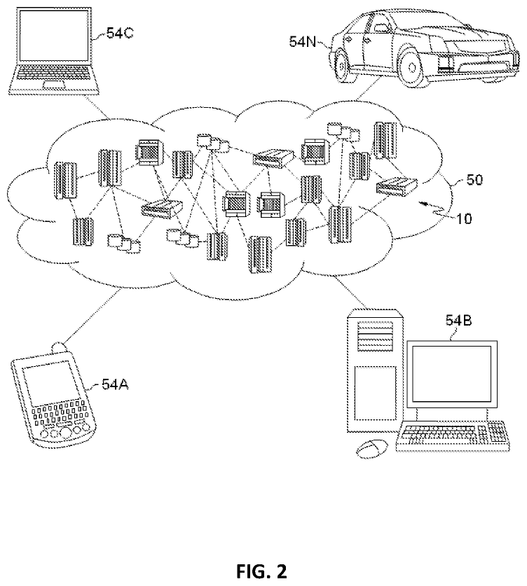

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

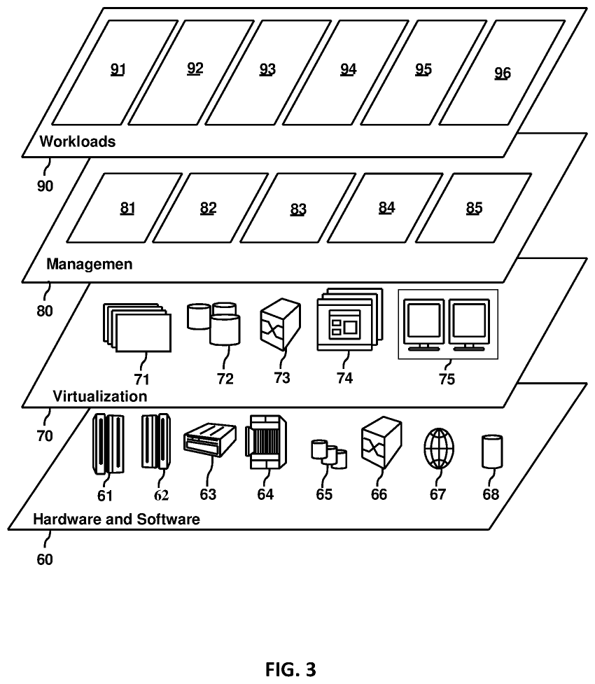

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database 730 software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and batch application performance prediction 96.

Regarding the batch application, various problems related to the performance are addressed through one or embodiments discussed herein. Specifically, batch processing typically suffers from occasional performance bottlenecks. In such cases, how to efficiently find the performance bottleneck becomes an issue. Traditionally, the system log files can be checked to find the performance bottleneck. However, the system log files are often too large to be easily checked for trouble shooting.

Alternatively, the performance of the batch application can be improved simply by enhancing or increasing the amount of the hardware resources, such as processing and/or storage resources, so as to relieve the performance bottleneck. However, how to balance the performance and the cost associated with enhancing or increasing the hardware resources is another problem to be addressed. Traditionally, it depends on the administrator experience to achieve the balance. However, the administrator experience is inaccurate and often wastes the hardware resources. If the hardware resources are overabundant, the hardware resources cannot be fully utilized. In this case, how to reasonably reduce or decrease the amount of the hardware resources is also a problem.

In addition, some batch applications need to be run daily and are required to be completed within a specified time. How to meet the run time requirements is yet another problem addressed by one or more embodiments described herein. Moreover, when the workload has been changed, either increased or decreased, due to the change of the batch applications or the change of the hardware resources, how to predict the performance is still another problem.

In order to at least partially solve one or more of the above problems and other potential problems, example embodiments of the present disclosure propose a solution for finding the performance bottleneck of the batch application and predicting the performance of the batch application when the workload or the hardware resource changes. One of the key factors which can be used to indicate the performance is the run time or the elapsed time of the batch application. Since a batch application consists of a plurality of transactions, the application run time of the batch application can be made up of the transaction run time of the plurality of transactions. Specifically, the application run time can be the sum of the transaction run time of the plurality of transactions.

To determine the transaction run time, a resource service time of the transaction and a time-resource model can be obtained. The time-resource model indicates a historical relationship among the resource service time, a resource wait time of the transaction and a reference resource utilization of a further transaction of a further application. Then, the transaction run time can be determined based on the obtained resource service time and time-resource model.

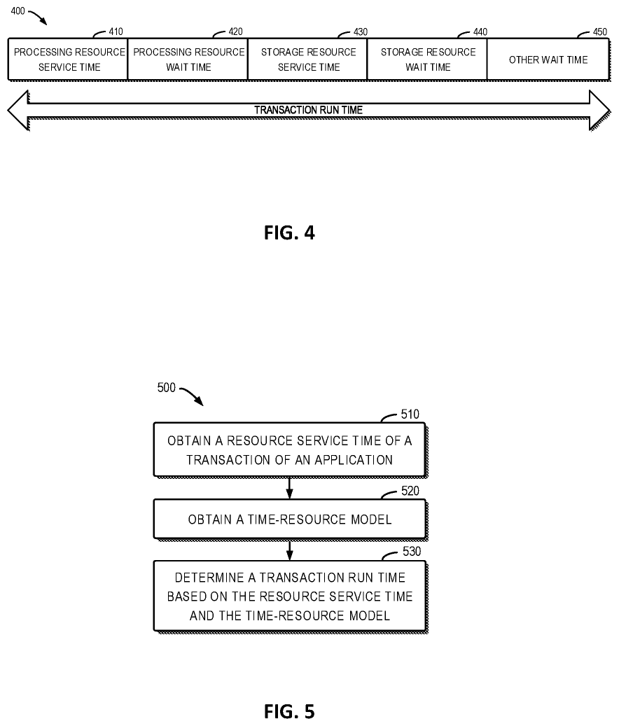

As described herein, the term “resource service time” refers to a time period when the transaction occupies a computer resource. The term “resource wait time” refers to a time period when the transaction waits for the computer resource to become available. The term “reference resource utilization” refers to a degree of the further transaction occupying the computer resource during a time period when the further transaction is running. These terms are explained in further detail below with reference to FIG. 4.

FIG. 4 depicts a schematic diagram of example transaction run time 400 according to one embodiment. As shown in FIG. 4, the transaction run time 400 consists of five components, including the processing resource service time 410, the processing resource wait time 420, the storage resource service time 430, the storage resource wait time 440 and the other wait time 450.

For example, the processing resource service time 410 may comprise a Central Processing Unit (CPU) burning time indicating a time period when the transaction occupies the CPU. The processing resource wait time 420 may comprise a CPU queuing time indicating a time period when the transaction waits in a waiting queue for the CPU to be assigned to it. The storage resource service time 430 may comprise an I/O service time indicating a time period when the transaction reads data from a storage and/or writes data into the storage. The storage resource wait time 440 may comprise an I/O queuing time indicating a time period when the transaction waits in a waiting queue for the storage to be assigned to it. In addition, the other wait time 450 may comprise a software wait time indicating a time period when the transaction waits for the application to be awake and/or waits for application resources to be assigned to it.

As used herein, the processing resource service time 410 and the storage resource service time 430 may be collectively referred to as “the resource service time”, and the processing resource wait time 420 and the storage resource wait time 440 may be collectively referred to as “the resource wait time”. The resource service time indicates a time period when the transaction occupies a computer resource (such as the processing resource and the storage resource), and the resource wait time indicates a time period when the transaction waits for the computer resource to become available.

Since the transaction run time consists of the above five components, to determine the transaction run time 400, these components should be determined first. Among these components, since the batch applications can be thought as running stably, the processing resource service time 410 and the storage resource service time 430 can be assumed to be unchanged or can be calculated from historical values. The historical values may be the values sampled during a time interval of a prior application execution. However, the historical values are not limited to the sampled values, but can also be predetermined values, for example.

For example, the processing resource service time 410 may depend on the type of the processing resource. When the type of the processing resource remains unchanged, the processing resource service time 410 is assumed to be unchanged and be the same as the historical processing resource service time, regardless of the increase or decrease in the number of the processing resource. Otherwise, when the type of the processing resource changes, the throughput of the processing resource (such as the commercial processing workload (CPW) of the CPU) changes, such that the processing resource service time 410 changes. However, even if the type of the processing resource changes, the processing resource service time 410 that changes with the type can be determined from the following equation:

T_{NPRST}*F_{NTPR}=T_{OPRST}*F_{OTPR} (1)

wherein T_{NPRST} represents the new processing resource service time, F_{NTPR} represents the new throughput of the processing resource, T_{OPRST} represents the original processing resource service time, and F_{OTPR} represents the original throughput of the processing resource.

On the contrary, the processing resource wait time 420 and the storage resource wait time 440 cannot be directly determined from the historical values. This is because the processing resource wait time 420 is varied according to the processing resource utilization, and the storage resource wait time 440 is varied according to the storage resource utilization. That is, the higher the processing resource utilization is, the longer the processing resource wait time 420 is, and the higher the storage resource utilization is, the longer the storage resource wait time 440 is. In this context, the processing resource utilization and the storage resource utilization may be collectively referred to as “the resource utilization.” The resource utilization indicates a degree of the transaction occupying the computer resource during a time period when the transaction is running.

To determine the processing resource wait time 420 and the storage resource wait time 440, the solution generates a processing resource time-resource model by performing curve fitting on the historical values of the processing resource service time 410, the processing resource wait time 420, and the processing resource utilization, and generates a storage resource time-resource model by performing curve fitting on the historical values of the storage resource service time 430, the storage resource wait time 440, and the storage resource utilization. The processing resource time-resource model indicates a historical relationship among the processing resource service time 410, the processing resource wait time 420 and the processing resource utilization. The storage resource time-resource model indicates a historical relationship among the storage resource service time 410, the storage resource wait time 420 and the storage resource utilization. As used herein, the processing resource time-resource model and the storage resource time-resource model may be collectively referred to as “the time-resource model.”

Additionally, the solution arranges all the applications to be executed into an application schedule. The start time and the end time of the applications split the time axis of the application schedule into a plurality of stages. Since the number of the applications competing for the processing resources and the storage resources remains unchanged in each stage, the processing resource utilization and the storage resource utilization also remain unchanged. Then, the solution determines the resource wait time and the resource utilization per transaction in each stage, such that the performance of the application can be predicted.

The composition of the transaction run time 400 is described above. An example predicting method 500 employing the transaction run time 400 and its components 410-450 according to one embodiment will be discussed with reference to FIG. 5. The method 500 can be implemented in the cloud computing node 10. The method 500 is only illustrative and is not intended to suggest any limitation as to the scope of use or functionality of embodiments of the disclosure described herein.

At 510, the cloud computing node 10 obtains a resource service time of a transaction of an application. As stated above, the resource service time indicates a time period when the transaction occupies a computer resource. The resource service time can be assumed to be unchanged, such that the resource service time can be directly determined from historical values. The resource service time may be obtained otherwise, for example, the resource service time may be a predetermined value.

At 520, the cloud computing node obtains a time-resource model. As stated above, the time-resource model indicates a historical relationship among the resource service time, the resource wait time and the resource utilization. Specifically, since the resource wait time is affected by the resource utilizations of the transactions of the other applications executed in the same stage (also referred to as “the reference resource utilization”), the time-resource model indicates a historical relationship among the resource service time, the resource wait time and the reference resource utilization.

In some embodiments, to obtain the time-resource model, the cloud computing node 10 may obtain historical values of the resource service time, the resource wait time, and the reference resource utilization, and generate the time-resource model by performing curve fitting on these obtained historical values. For example, the curve fitting may use the least square method. It is understood that the technique employed to perform the curve fitting is not limited to the least square method, but can also be any other curve fitting method, such as, but not limited to, Lagrangian interpolation, Newton interpolation and the like.

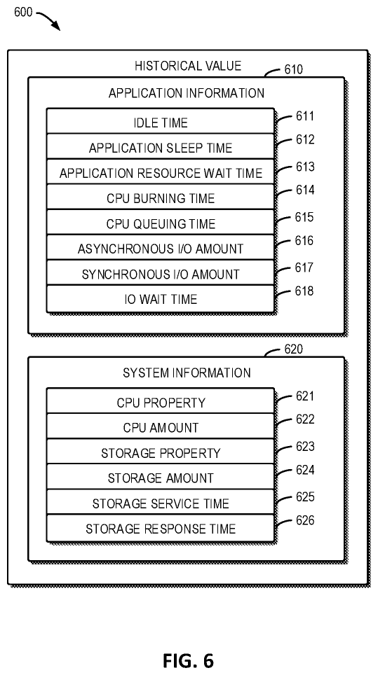

Specifically, the cloud computing node 10 may obtain the historical values of the processing resource service time, the processing resource wait time, and the reference processing resource utilization, and generate the processing resource time-resource model by performing curve fitting on the obtained historical values related to the processing resource. Similarly, the cloud computing node 10 may obtain the historical values of the storage resource service time, the storage resource wait time, and the reference storage resource utilization, and generate the storage resource time-resource model by performing curve fitting on the obtained historical values related to the storage resource. A more detailed description of the historical values is described with reference to FIG. 6.

FIG. 6 depicts an example schematic diagram of historical values 600 according to one embodiment. It should be understood that, the historical values 600 are each sampled during a time interval of a prior application execution. As shown in FIG. 6, the historical values 600 include the application information 610 and the system information 620. The application information 610 and the system information 620 may include a plurality of parameters. For example, the application information 610 may include the idle time 611, the application sleep time 612, the application resource wait time 613, the CPU burning time 614, the CPU queuing time 615, the asynchronous I/O amount 616, the synchronous I/O amount 617, the IO wait time 618 and the like. The system information 620 may include the CPU property 621, the CPU amount 622, the storage property 623, the storage amount 624, the storage resource service time 625, the storage response time 626 and the like.

The resource service time, the resource wait time, the reference resource utilization, the other wait time and other factors required to predict the performance, such as the number of the transactions contained in the application, can be derived from the above listed parameters. For example, among these parameters, the application sleep time 612 and the application resource wait time 613 can contribute to the other wait time. The CPU burning time 614 can contribute to the processing resource service time. The CPU queuing time 615 can contribute to the processing resource wait time. The asynchronous I/O amount 616 and the synchronous I/O amount 617 can contribute to the number of the transactions contained in the application. The CPU property 621 can contribute to the type of the processing resource, and thus can contribute to the processing resource service time. The storage resource service time 625 can contribute to the storage resource service time. The storage response time 626 can contribute to the storage resource service time and the storage resource wait time. For example, the cloud computing node 10 may obtain the CPU burning time 614 and the synchronous I/O amount 617, and determine the processing resource service time by dividing the CPU burning time 614 by the synchronous I/O amount 617.

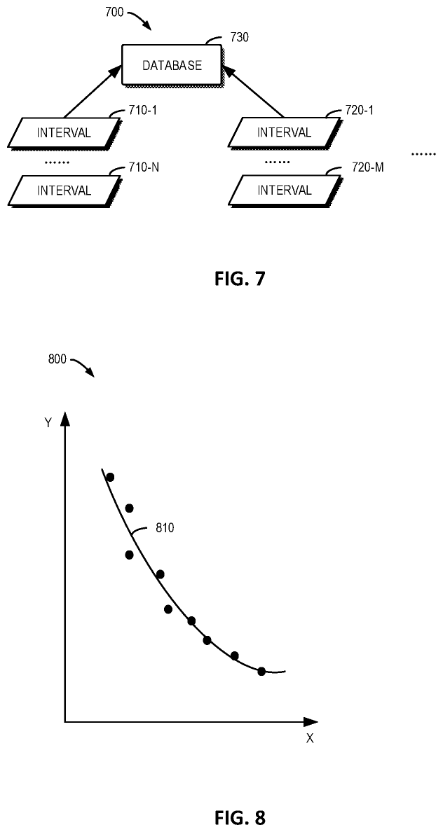

In some embodiments, the cloud computing node 10 may obtain the historical values 600 from a database. FIG. 7 depicts a schematic diagram 700 of collecting the historical values in a database 730 according to an embodiment of the present invention. As shown in FIG. 7, the database 730 may collect the historical values during the intervals 710-1 . . . 710-N in prior executions of an application, and collect the historical values during the intervals 720-1 . . . 720-M in prior executions of another application, in which N and M are integers larger than 0. It should be understood that, historical values of other applications can also be collected.

After obtaining the historical values of the resource service time, the resource wait time, and the resource utilization, the cloud computing node 10 may generate the time-resource model by performing curve fitting on the historical values. For example, the time-resource model may be modeled, based on the historical values, as:

T_{RWT}=F(U_{RU},T_{RST}) (2)

wherein T_{RWT} represents the resource wait time, U_{RU} represents the resource utilization, T_{RST} represents the resource service time, and F represents the function of the resource wait time, the resource utilization and the resource service time.

Specifically, as stated above, since the resource wait time is affected by the reference resource utilization of the transactions of the other applications executed in the same stage, the time-resource model may be modeled as:

T_{RWT}=F(U_{RRU},T_{RST}) (3)

wherein T_{RWT} represents the resource wait time, U_{RRU} represents the reference resource utilization, T_{RST} represents the resource service time, and F represents the function of the resource wait time, the reference resource utilization and the resource service time.

FIG. 8 depicts an example schematic diagram 800 of performing curve fitting on historical values to determine a curve 810 representing a time-resource model according to one embodiment. As shown in FIG. 8, the discrete points represent the historical values of respective time intervals. The X-axis represents a factor relating to the resource service time and the resource wait time. For example, the factor may be the sum of the resource service time and the resource wait time dividing the resource service time. The Y-axis represents a factor relating to the reference processing utilization. For example, the factor may be one minus the reference processing utilization.

For example, the time-resource model may be modeled as:

T_{RST}T_{RWT}=T_{RST}*(K/(1−U_{RRU})) (4)

wherein T_{RST} represents the resource service time, T_{RWT} represents the resource wait time, U_{RRU} represents the reference resource utilization, and K is a factor derived using the curve fitting method (such as the least square method). In some embodiments, the gradient with the minimal error can be used as K.

Additionally, it should be understood that, for an application, the reference resource utilization is the difference between the resource utilization and the total resource utilization of all the transactions of all the applications, that is:

U_{RRU}=U_{TRU}−U_{RU} (5)

wherein U_{RRU} represents the reference resource utilization, U_{TRU} represents the total resource utilization, and U_{RU} represents the resource utilization.

Specifically, for the processing resource, the curve 810 may be modeled as:

T_{PRST}+T_{PRWT}=T_{PRST}*(K/(1−U_{RPRU})) (6)

wherein T_{PRST} represents the processing resource service time, T_{PRWT} represents the processing resource wait time, U_{RPRU} represents the reference processing resource utilization, and K is a factor derived using the curve fitting method.

Again, for an application, the reference processing resource utilization is the difference between the total processing resource utilization and the processing resource utilization, that is:

U_{RPRU}=U_{TPRU}−U_{PRU} (7)

wherein U_{RPRU} represents the reference processing resource utilization, U_{TPRU} represents the total processing resource utilization, and U_{PRU} represents the processing resource utilization.

Likewise, for the storage resource, the curve 810 may be modeled as:

T_{SRST}+T_{SRWT}=T_{SRST}*(K/(1−U_{RSRU}) (8)

wherein T_{SRST} represents the storage resource service time, T_{SRWT} represents the storage resource wait time, and U_{RSRU} represents the reference storage resource utilization.

Again, for an application, the reference storage resource utilization is the difference between the total storage resource utilization and the storage resource utilization, that is:

U_{RSRU}=U_{TSRU}−U_{SRU} (9)

wherein U_{RSRU} represents the reference storage resource utilization, U_{TSRU} represents the total storage resource utilization, and U_{SRU} represents the storage resource utilization.

In some embodiments, as an alternative to determining the curve 810 representing the resource-time model based on the historical values, the resource-time model may be obtained in other manners. For example, in some embodiments, the resource-time model may be a predetermined model that can be obtained and used directly.

Referring back to FIG. 5, at 530, the cloud computing node 10 determines the transaction run time based on the resource service time and the time-resource model. As stated above, to determine the transaction run time, the resource wait time and the resource utilization should first be determined. The resource wait time and the resource utilization can be determined by applying the resource service time to the time-resource model. Since the resource wait time and the resource utilization are affected by each other, the resource wait time and the resource utilization can be determined iteratively until the determined results converge, that is to say, the change of the determined resource utilization for two successive iterations is below a predetermined threshold.

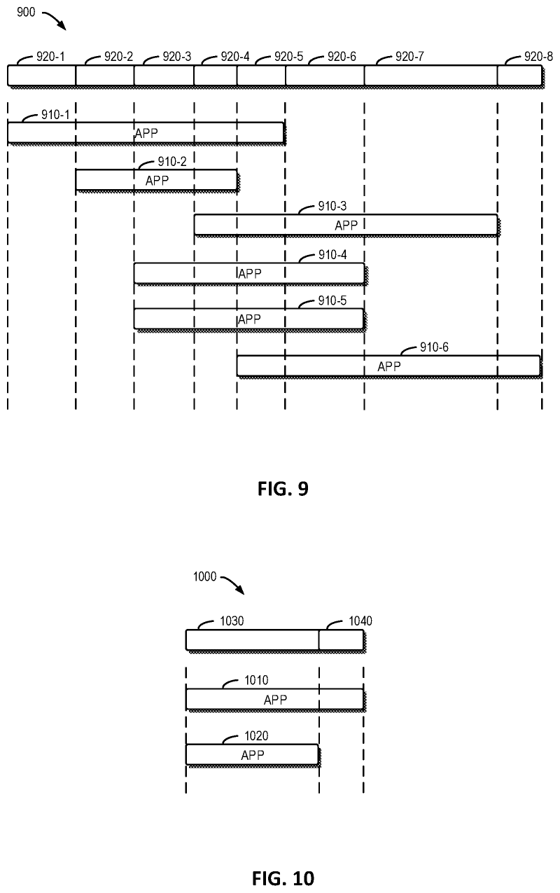

In some embodiments, the cloud computing node 10 may arrange all the applications to be executed into an application schedule based on start time and end time of the applications. FIG. 9 depicts an example schematic diagram of an example application schedule 900 according to one embodiment. As shown in FIG. 9, the application schedule 900 contains six applications 910-1 . . . 910-6. These applications split the application schedule into eight stages 920-1 . . . 920-8 based on their respective start times and end times.

It can be seen that the number of applications competing for the resources remains unchanged in each stage, such that the resource wait time and the resource utilization also remain unchanged, and the transactions executed in a single stage are running stably. In this case, the cloud computing node 10 may determine the resource wait time and the resource utilization per transaction in each stage, such that the performance of the application can be predicted.

In some embodiments, the cloud computing node 10 may determine the stages based on a predetermined value associated with the number of transactions of an application. For example, the application 910-2 may be specified to be executed only after ten percent of the total number of the transactions of the application 910-1 complete execution, or only after one thousand transactions of the application 910-1 complete execution.

Then, the cloud computing node 10 may iteratively determine the resource wait time and the resource utilization of the transaction of each application based on the time-resource model and the resource service time in each stage, so as to determine the transaction run time of the transaction of each application in each stage. When the resource utilization determined in one stage converges, the cloud computing node 10 may continue to iteratively determine the resource wait time and the resource utilization in the next stage.

As the first step of the iteration, the cloud computing node 10 may initialize the reference resource utilization to a predetermined value. For example, the cloud computing node 10 may initialize the reference processing resource utilization and the reference storage resource utilization to zero. In some embodiments, the cloud computing node 10 may also initialize the resource wait time to a predetermined value, such as zero.

The cloud computing node 10 may determine an intermediate resource wait time by applying the initial reference resource utilization and the resource service time to the time-resource model. For example, the cloud computing node 10 may determine an intermediate processing resource wait time by applying the initial reference processing resource utilization and the processing resource service time to the time-resource model for the processing resource. Likewise, the cloud computing node 10 may determine an intermediate storage resource wait time by applying the initial reference storage resource utilization and the storage resource service time to the time-resource model for the storage resource.

Then, the cloud computing node 10 may determine an intermediate transaction run time based on the determined intermediate resource wait time and the resource service time. As stated above, the transaction run time is the sum of the resource wait time, the resource service time and the other wait time. In this case, the intermediate transaction run time is the sum of the intermediate processing resource wait time, the intermediate storage resource wait time, the processing resource service time, the storage resource service time and the other software wait time.

Next, the cloud computing node 10 may determine an intermediate resource utilization based on a ratio of the resource service time to the intermediate transaction run time, since the resource utilization indicates a degree of a transaction occupying the computer resource during a time period when the transaction is running. For example, the intermediate resource utilization is determined by dividing the resource service time by the intermediate transaction run time. In some embodiments, in determining the intermediate resource utilization, the cloud computing node 10 may determine a temporary resource utilization by weighting the ratio and the intermediate resource utilization, and update the intermediate resource utilization with the temporary resource utilization. For example, the cloud computing node 10 may determine the temporary resource utilization by averaging the ratio and the intermediate resource utilization, and using the averaged temporary resource utilization as the new intermediate resource utilization.

Note that although the above text describes a process for determining the intermediate resource utilization of a specific application, the intermediate resource utilizations of the other applications to be executed in the same stage are also determined in a similar manner In this case, the total resource utilization which is the sum of the resource utilizations of all the applications to be executed in the same stage can be determined by the cloud computing node 10. In the case that the total resource utilization exceeds a hundred percent, the total resource utilization can be set to a hundred percent, to avoid the resource utilization exceeding the proper limitation.

Then, the cloud computing node 10 may determine whether a difference between the total resource utilization and a last determined total resource utilization in the previous iteration is below a predetermined threshold, so as to determine whether the total resource utilization converges. In response to determining that the difference is below the predetermined threshold, the cloud computing node 10 may determine the transaction run time based on the resource wait time corresponding to the total resource utilization and the resource service time.

The convergence can be determined otherwise, for example, the cloud computing node 10 may determine whether a difference between the resource utilization and a last determined resource utilization in the previous iteration of each of the applications is below a predetermined threshold, so as to determine whether the resource utilization converges. In response to determining that the difference is below the predetermined threshold, the cloud computing node 10 may determine the transaction run time based on the resource wait time corresponding to the resource utilization and the resource service time.

If the difference is not below the predetermined threshold, the cloud computing node 10 may enter into the next iteration. In the next iteration, the cloud computing node 10 may apply the resource service time and the reference resource utilization to the resource-time model to determine the resource wait time, so as to determine the transaction run time, where the reference resource utilization is the sum of the intermediate resource utilizations of the other applications determined in the previous iteration.

After determining the transaction run time, the time span of the application in the stage can be determined based on the transaction run time and the number of the transactions included in the application. For example, as described above, there may be one thousand transactions in the stage 920-1 of the application 910-1. In this case, the time span of the application 910-1 in the stage 920-1 is:

T_{TS}=1000*T_{TRT} (10)

wherein T_{TS} represents the time span of the application 910-1 in the stage 920-1, and T_{TRT} represents the transaction run time. The cloud computing node 10 may determine the time spans of the application in the other stages in a similar manner Finally, the application run time can be determined by adding the time spans of the application in all the stages.

As stated above, when determining the transaction run time of the application 910-1, the transaction run time of the other applications is also determined, and the time spans of the all the application in the same stage are the same. In this case, the number of the transactions included in another application to be executed in the same stage can also be determined based on the determined time span and the transaction run time of the other application. For example, the number of the transactions included in the application 910-2 is:

N_{T2}=1000*T_{TRT1}/T_{TRT2} (11)

wherein N_{T2} represents the number of the transactions included in the application 910-2, T_{TRT1} represents the transaction run time of the application 910-1, and T_{TRT2} represents the transaction run time of the application 910-2. In this case, the application run time of the other applications can also be determined.

With the solution of the present disclosure, the performance of the batch application can be predicted more accurately, and the performance bottleneck of the bath application can be found more efficiently.

A specific example of how to determine the application run time will be described below in detail. FIG. 10 depicts an example schematic diagram of an example application schedule 1000 according to one embodiment. As shown in FIG. 10, the application schedule 1000 contains two applications 1010 and 1020 which split the application schedule 1000 into two stages 1030 and 1040. Such illustration is for example purposes only and it is to be understood that the number of applications and the number of stages are not limited to those discussed in the example embodiments described herein.

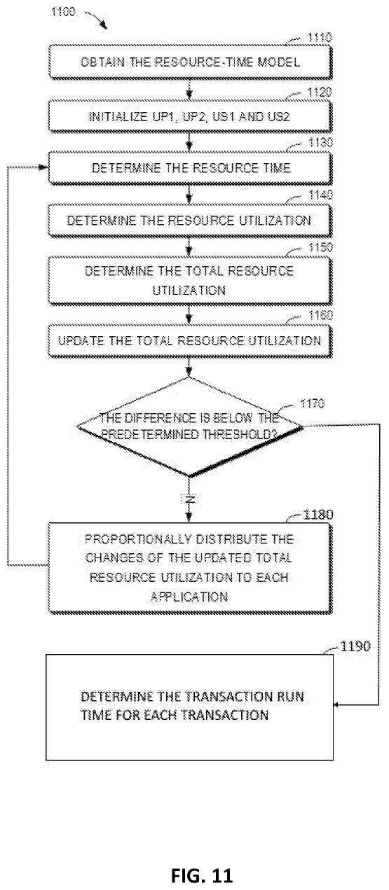

In the example embodiment, it is assumed that the number of the processing resource has been increased from one processing resource to two processing resource, the following text will describe how to predict the performance of the applications in this case. Reference is now made to FIG. 11, in which a flow chart of an example predicting method 1100 according to one embodiment is shown.

At 1110, the cloud computing node 10 obtains the resource-time model based on the collected historical values from the database 730. According to the historical values, for the application 1010 in this example, the number of the transactions is 200 and the processing resource service time is 200 s. Thus, for each transaction in the application 1010 in this example, the processing resource service time is: 200 s/200=1 s. In some embodiments, there may be other wait time. However, for the sake of simplicity and ease of explanation, it is assumed that the other wait time is 0 s.

Additionally, the cloud computing node 10 may generate the time-resource model for the processing resource of the application 1010 by performing curve fitting on the historical values of the processing resource service time, the processing resource wait time, and the processing resource utilization of the application 1020. The generated time-resource model may be:

T_{PRT1}=1/(1−U_{PRU2})*T_{PRST1} (12)

wherein T_{PRT1} represents the processing resource time of the application 1010, which is the sum of the processing resource wait time and the processing resource service time of the application 1010, U_{PRU2} represents the processing resource utilization of the application 1020, and T_{PRST1} represents the processing resource service time of the application 1010.

In addition, according to the historical values in this example, the storage resource service time is 0.01 s. The cloud computing node 10 may also generate the time-resource model for the storage resource of the application 1010 by performing curve fitting on the historical values of the storage resource service time, the storage resource wait time, and the storage resource utilization of the application 1020. The generated time-resource model may be:

T_{SRT1}=0.5/(1−U_{SRU2})*T_{SRST1}, if U_{SRU2}>0.5

T_{SRT1}=T_{SRST1}=0.01, if U_{SRU2}<0.5 (13)

wherein T_{SRT1} represents the storage resource time of the application 1010, which is the sum of the storage resource wait time and the storage resource service time of the application 1010, T_{SRST1} represents the storage resource service time of the application 1010, and U_{SRU2} represents the storage resource utilization of the application 1020.

Similarly, according to the historical values, for the application 1020 in this example, the number of the transactions is 10 and the processing resource service time is 30 s. Thus, for each transaction in the application 1020 in this example, the processing resource service time is: 30 s/10=3 s. In some embodiments, there may be other wait time. However, for the sake of simplicity and ease of explanation, it is assumed that the other wait time is 0 s.

Additionally, the cloud computing node 10 may generate the time-resource model for the processing resource of the application 1020 by performing curve fitting on the historical values of the processing resource service time, the processing resource wait time, and the processing resource utilization of the application 1010. The generated time-resource model may be:

T_{PRT2}=1.2/(1−U_{PRU1})*T_{PRST2} (14)

wherein T_{PRT2} represents the processing resource time of the application 1020, which is the sum of the processing resource wait time and the processing resource service time of the application 1020, T_{PRST2} represents the processing resource service time of the application 1020, and U_{PRU1} represents the processing resource utilization of the application 1010.

In addition, according to the historical values, the storage resource service time is 0.01 s in this example. The cloud computing node 10 may also generate the time-resource model for the storage resource of the application 1020 by performing curve fitting on the historical values of the storage resource service time, the storage resource wait time, and the storage resource utilization of the application 1010. The generated time-resource model may be:

T_{SRT2}=0.5/(1−U_{SRU1})*T_{SRST2}, if U_{SRU1}>0.5

T_{SRT2}=T_{SRST}2=0.01, if U_{SRU1}<0.5 (15)

wherein T_{SRT2} represents the storage resource time of the application 1020, which is the sum of the storage resource wait time and the storage resource service time of the application 1020, T_{SRST2} represents the storage resource service time of the application 1020, and U_{SRU1} represents the storage resource utilization of the application 1010.

Then, the cloud computing node 10 iteratively determines the transaction run time of the applications 1010 and 1020 in the stage 1030. At 1120, the cloud computing node initializes the processing resource utilizations and the storage resource utilizations of the applications 1010 and 1020 to 0. In this case, the total processing resource utilization, which is the sum of the processing resource utilizations of the applications 1010 and 1020, is initialized to 0, and the total storage resource utilization, which is the sum of the storage resource utilizations of the applications 1010 and 1020, is also initialized to 0.

At 1130, the cloud computing node 10 determines, for the applications 1010 and 1020, the resource time based on the resource-time model. For the application 1010, the processing resource time is determined based on the above Equation (12). Since the processing resource utilization of the application 1020 U_{PRU2} is 0 and the processing resource service time T_{PRST1} is 1, in this example, the processing resource time T_{PRT1} can be determined to be 1 (that is, 1/(1−0)*1=1). Additionally, based on the above Equation (13), the storage resource time is determined to be 0.01, in this example. For the application 1020, the processing resource time is determined based on the above Equation (14). Since the processing resource utilization of the application 1010 U_{PRU1} is 0 and the processing resource service time T_{PRST2} is 3, the processing resource time T_{PRT2} can be determined to be 3.6 (that is, 1.2/(1−0)*3=3.6), in this example. Additionally, based on the above Equation (15), the storage resource time is determined to be 0.01, in this example.

At 1140, the cloud computing node 10 determines the resource utilizations for the applications 1010 and 1020. As stated above, the resource utilization is the ratio of the resource service time and the transaction run time, and the transaction run time is the sum of the resource service time, the resource wait time and the other wait time. In this case, for the application 1010, it has been determined that the processing resource service time is 1, the storage resource service time is 0.01, and the processing resource wait time, the storage resource wait time and the other wait time are all 0, in this illustrative example. Thus, the processing resource utilization is 99% (that is, 1/(1+0.01)=99%), and the storage resource utilization is 0.99% (that is, 0.01/(1+0.01)=0.99%), using the example values in this illustrative example. Similarly, for the application 1020, the processing resource utilization is 83.1% (that is, 3/(3.6+0.01)=83.1%), and the storage resource utilization is 0.28% (that is, 0.01/(3.6+0.01)=0.28%), using the example values in this illustrative example.

At 1150, the cloud computing node 10 determines the total resource utilization of a computer resource for the applications 1010 and 1020. The total resource utilization is determined by dividing the sum of all the resource utilizations of all the applications to be executed in the same stage by the number of the resources. In this example, since the processing resource utilizations of the applications 1010 and 1020 are 99% and 83.1%, respectively, the total processing resource utilization can be determined to be 91.05% (that is, (99%+83.1%)/2=91.05%). Similarly, the total storage resource utilization can be determined to be 0.127% (that is, (0.99%+0.28%)/10=0.127%) using the example values in this illustrative example.

At 1160, the cloud computing node 10 updates the total resource utilization with the median of the total resource utilization determined in two latest iterations. In other words, the average of the total resource utilization determined in two latest iterations can be determined as the updated total resource utilization. In this example, since the total processing resource utilization in the previous iteration is 0, and the total processing resource utilization in the current iteration is 91.05%, the updated total processing resource utilization can be determined to be 45.525% (that is, (0+91.05%)/2=45.525%). Similarly, the updated total storage resource utilization can be determined to be 0.0635% (that is, (0+0.127%)/2) using the example values in this illustrative example.

At 1170, the cloud computing node 10 determines whether the difference between the total resource utilizations in two latest iterations is below the predetermined threshold. If the difference is not below the threshold, at 1180, the cloud computing node 10 proportionally distributes the changes of the updated total resource utilization to each application. In this example, for the application 1010, since the processing resource utilization of the application 1010 is 99%, the processing resource utilization of the application 1020 is 83.1%, and the updated total processing resource utilization is 45.525%, the updated processing resource utilization can be determined to be 24.75% (that is, 99%/(99%+83.1%)*45.525%=24.75%). Similarly, the updated storage resource utilization can be determined to be 0.0495% (that is, 0.99%/(0.99%+0.28%)*0.0635%=0.0495%) using the example values of this illustrative example. Likewise, for the application 1020, the updated processing resource utilization can be determined to be 20.775% (that is, 83.1%/(99%+83.1%)*45.525%=20.775%), and the updated storage resource utilization can be determined to be 0.014% (that is, 0.28%/(0.99%+0.28%)*0.0635%=0.014%), using the example values of this illustrative example.

Then, the cloud computing node 10 starts the next iteration, and repeats the actions described above with respect to blocks 1130-1180. During the next iteration at 1130, the cloud computing node 10 determines, for the applications 1010 and 1020, the resource time based on the resource-time model. At this point, the resource utilization is the resource utilization determined in the previous iteration. For the application 1010, based on the Equation (12), the processing resource time can be determined to be 1.26 (that is, 1/(1−20.775%)*1=1.26), in this example. Additionally, based on the Equation (13), the storage resource time can be determined to be 0.01, in this example. For the application 1020, based on the Equation (14), the processing resource time can be determined to be 4.78 (that is, 1.2/(1−24.75%)*3=4.78), in this example. In addition, based on the Equation (15), the storage resource time can be determined to be 0.01, in this example.

During the next iteration at 1140, the cloud computing node 10 determines the resource utilizations for the applications 1010 and 1020 in a similar manner to that of 1140 described above. For the application 1010, the processing resource utilization can be determined to be 78.74% (that is, 1/(1.26+0.01)=78.74%), and the storage resource utilization can be determined to be 0.79% (that is, 0.01/(1.26+0.01)=0.79%), in this example. For the application 1020, the processing resource utilization can be determined to be 62.63% (that is, 3/(4.78+0.01)=62.63%), and the storage resource utilization can be determined to be 0.21% (that is, 0.01/(4.78+0.01)=0.21%), in this example.

During the next iteration at 1150, the cloud computing node 10 determines the total resource utilization of a computer resource for the applications 1010 and 1020 in a similar manner with that of 1150 described above. In this example, the total processing resource utilization can be determined to be 70.685% (that is, (78.74%+62.63%)/2=70.685%). Additionally, the total storage resource utilization can be determined to be 0.1% (that is, (0.79%+0.21%)/10=0.1%) in this example.

During the next iteration at 1160, the cloud computing node 10 updates the total resource utilization with the median of the total resource utilization determined in two latest iterations in a similar manner to that of 1160 discussed above. In this example, the updated total processing resource utilization can be determined to be 58.105% (that is, (45.525%+70.685%)/2=58.105%), and the updated total processing resource utilization can be determined to be 0.08175% (that is, (0.0635%+0.1%)/2=0.08175%) in this example.

During the next iteration at 1170, the cloud computing node 10 determines whether the difference between the total resource utilizations in two latest iterations is below the predetermined threshold. If the difference is not below the threshold, at 1180, the cloud computing node 10 proportionally distributes the changes of the updated total resource utilization to each application in a similar manner to that of 1180 discussed above. In this example, for the application 1010, the updated processing resource utilization can be determined to be 32.36% (that is, 78.74%/(78.74%+62.63%)*58.105%=32.36%), and the updated storage resource utilization can be determined to be 0.079% (that is, 0.79%/(0.79%+0.21%)*0.1%=0.079%). For the application 1020, the updated processing resource utilization can be determined to be 25.74% (that is, 62.63%/(78.74%+62.63%)*58.105%=25.74%), and the updated storage resource utilization can be determined to be 0.021% (that is, 0.21%/(0.79%+0.21%)*0.1%=0.021%), in this example.

The cloud computing node 10 performs the iteration until the total resource utilization convergences. Alternatively, the cloud computing node 10 performs the iteration until the resource utilization convergences. For example, the cloud computing node 10 performs the iteration until the changes of the updated processing resource utilizations and the updated storage resource utilizations of the applications 1010 and 1020 in two successive iteration are determined to be below the predetermined threshold at 1170.

When the resource utilization converges, the cloud computing node 10 determines the transaction run time for each transaction, which is the sum of the current processing resource time and the current storage resource time. Furthermore, for the application 1020 in this example, since the number of the transactions in the application 1020 and the transaction run time are both determined, the application run time of the application 1020 can be determined. Since the application run time of the application 1020 equals the time span of the stage 1030 in this example, the number of the transactions in the application 1010 can be determined, in this example, by dividing the time span of the stage 1030 by the transaction run time of the application 1010, such that the number of the transactions of the application 1010 completed in the stage 1030 can be determined.

Then, the cloud computing node 10 determines the time span of the stage 1040 in a similar manner. The cloud computing node 10 determines the transaction run time of the application 1010 in the stage 1040 and the number of the transactions of the application 1010 remaining to be completed. Then, the cloud computing node 10 determines the time span of the stage 1040 by multiplying the transaction run time of the application 1010 in the stage 1040 and the remaining number of the transactions of the application 1010 in the stage 1040. Finally, the application run time of the application 1010 can be determined by adding up the time spans 1030 and 1040. In this example, the application run time of the applications 1010 and 1020 are both determined.

The tables below show example predicting results of embodiments of the present disclosure using example applications. It can be seen that the illustrative prediction results and the real results are very close. For example, with respect to example application A in Table 1, the real result measured to be 12 hours and 7 minutes is very similar to the prediction result which is 12 hours and 16 minutes.

TABLE 1
upgrade the type of the processing resource

| | Real result | Prediction result |
|---|---|---|
| Application A | 12 hours, 07 minutes | 12 hours, 16 minutes |
| Application B | 3 hours, 23 minutes | 3 hours, 39 minutes |

TABLE 2
increase the number of the processing resource

| | Real result | Prediction result |
|---|---|---|
| Application A | 9 hours, 53 minutes | 10 hours, 03 minutes |
| Application B | 2 hours, 55 minutes | 2 hours, 55 minutes |

Thus, with the solution of embodiments of the present disclosure, the performance of the batch processing can be predicted more accurately, and the performance bottleneck of the batch processing can be found more efficiently as compared to the conventional techniques discussed above. Thus, it is further to be understood, that through the use of the embodiments described herein, more efficient use of computer resources can be achieved as a result of the more efficient prediction of the performance bottleneck, for example.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining a resource service time of a transaction of an application, the resource service time indicating a time period when the transaction occupies a computer resource;
obtaining a time-resource model, the time-resource model indicating a historical relationship among the resource service time, a resource wait time of the transaction, and a reference resource utilization of a second transaction of a second application, the resource wait time indicating a time period when the transaction waits for the computer resource to become available, and the reference resource utilization indicating a degree of the second transaction occupying the computer resource during a time period when the second transaction is running; and
determining a transaction run time based on the resource service time and the time-resource model, the transaction run time indicating a time period when the transaction is running.

2. The method of claim 1, wherein obtaining the time-resource model comprises:
obtaining historical values of the resource service time, the resource wait time, and the reference resource utilization; and
generating the time-resource model by performing curve fitting on the historical values of the resource service time, the resource wait time, and the reference resource utilization.

3. The method of claim 1, wherein determining the transaction run time comprises:
determining an intermediate resource wait time by applying an initial reference resource utilization of the second transaction and the resource service time to the time-resource model;
determining an intermediate transaction run time based on the intermediate resource wait time and the resource service time;
determining an intermediate resource utilization based on a ratio of the resource service time to the intermediate transaction run time; and
determining the transaction run time based on the intermediate resource utilization.

4. The method of claim 3, wherein determining the intermediate resource utilization comprises:
determining a first resource utilization by weighting the ratio and the intermediate resource utilization; and
updating the intermediate resource utilization with the first resource utilization.

5. The method of claim 3, wherein determining the transaction run time based on the intermediate resource utilization comprises:
determining an intermediate reference resource utilization of the second transaction based on the intermediate resource utilization; and
determining the transaction run time based on the intermediate reference resource utilization.

6. The method of claim 5, wherein determining the transaction run time based on the intermediate reference resource utilization comprises:
determining a total resource utilization of the transaction based on the intermediate resource utilization and the intermediate reference resource utilization; and
determining the transaction run time based on the total resource utilization of the transaction.

7. The method of claim 6, wherein determining the transaction run time based on the total resource utilization of the transaction comprises:
determining whether a difference between the total resource utilization and a last determined total resource utilization is below a predetermined threshold; and
in response to determining the difference being below a predetermined threshold, determining the transaction run time based on the resource wait time corresponding to the total resource utilization and the resource service time.

8. The method of claim 1, wherein determining the transaction run time comprises:
determining a plurality of stages based on a predetermined value associated with a number of transactions of the application; and
determining the transaction run time in each of the plurality of stages.

9. The method of claim 1, further comprising:
determining an application run time based on the transaction run time and a number of transactions included in the application, the application run time indicating a time period when the application is running.

10. The method of claim 1, wherein the computer resource includes at least one of processing resources and storage resources.

11. A device comprising:
a processing unit; and
a memory coupled to the processing unit and storing instructions thereon, the instructions, when executed by the processing unit, performing acts comprising:
obtaining a resource service time of a transaction of an application, the resource service time indicating a time period when the transaction occupies a computer resource;
obtaining a time-resource model, the time-resource model indicating a historical relationship among the resource service time, a resource wait time of the transaction, and a reference resource utilization of a second transaction of a second application, the resource wait time indicating a time period when the transaction waits for the computer resource to become available, and the reference resource utilization indicating a degree of the second transaction occupying the computer resource during a time period when the second transaction is running; and
determining a transaction run time based on the resource service time and the time-resource model, the transaction run time indicating a time period when the transaction is running.

12. The device of claim 11, wherein obtaining the time-resource model comprises:
obtaining historical values of the resource service time, the resource wait time, and the reference resource utilization; and
generating the time-resource model by performing curve fitting on the historical values of the resource service time, the resource wait time, and the reference resource utilization.

13. The device of claim 11, wherein determining the transaction run time comprises:
determining an intermediate resource wait time by applying an initial reference resource utilization of the second transaction and the resource service time to the time-resource model;
determining an intermediate transaction run time based on the intermediate resource wait time and the resource service time;
determining an intermediate resource utilization based on a ratio of the resource service time to the intermediate transaction run time; and
determining the transaction run time based on the intermediate resource utilization.

14. The device of claim 13, wherein determining the intermediate resource utilization comprises:
determining a first resource utilization by weighting the ratio and the intermediate resource utilization; and
updating the intermediate resource utilization with the first resource utilization.

15. The device of claim 13, wherein determining the transaction run time based on the intermediate resource utilization comprises:
determining an intermediate reference resource utilization of the second transaction based on the intermediate resource utilization; and
determining the transaction run time based on the intermediate reference resource utilization.

16. The device of claim 15, wherein determining the transaction run time based on the intermediate reference resource utilization comprises:
determining a total resource utilization of the transaction based on the intermediate resource utilization and the intermediate reference resource utilization; and
determining the transaction run time based on the total resource utilization of the transaction.

17. The device of claim 16, wherein determining the transaction run time based on the total resource utilization of the transaction comprises:
determining whether a difference between the total resource utilization and a last determined total resource utilization is below a predetermined threshold; and
in response to determining the difference being below a predetermined threshold, determining the transaction run time based on the resource wait time corresponding to the total resource utilization and the resource service time.

18. The device of claim 11, wherein determining the transaction run time comprises:
determining a plurality of stages based on a predetermined value associated with a number of transactions of the application; and
determining the transaction run time in each of the plurality of stages.

19. The device of claim 11, further comprising:
determining an application run time based on the transaction run time and a number of transactions included in the application, the application run time indicating a time period when the application is running.

20. A computer program product being tangibly stored on a non-transient machine-readable medium and comprising machine-executable instructions, the instructions, when executed on a device, causing the device to:
obtain a resource service time of a transaction of an application, the resource service time indicating a time period when the transaction occupies a computer resource;
obtain a time-resource model, the time-resource model indicating a historical relationship among the resource service time, a resource wait time of the transaction, and a reference resource utilization of a further transaction of a further application, the resource wait time indicating a time period when the transaction waits for the computer resource to become available, and the reference resource utilization indicating a degree of the further transaction occupying the computer resource during a time period when the further transaction is running; and
determine a transaction run time based on the resource service time and the time-resource model, the transaction run time indicating a time period when the transaction is running.
